(19) United States
(12) Patent Application Publication
(10) Pub. No.: US 2010/0198760 A1
(43) Pub. Date: Aug. 5, 2010

(54) APPARATUS AND METHODS FOR MUSIC SIGNAL ANALYSIS

(75) Inventors: Namunu C. Maddage, Singapore (SG); Haizhou Li, Singapore (SG)

Correspondence Address: GREENBLUM & BERNSTEIN, P.L.C., 1950 ROLAND CLARKE PLACE, RESTON, VA, 20191, US

(73) Assignee: AGENCY FOR SCIENCE, TECHNOLOGY AND RESEARCH, Singapore (SG)

(21) Appl. No.: 12/440,337

(22) PCT Filed: Sep. 7, 2007
(86) PCT No.: PCT/SG2007/000299

§ 371 Date: Jul. 24, 2009

Related U.S. Application Data
(60) Provisional application No. 60/843,496, filed on Sep. 7, 2006.

(51) Int. Cl. G06N 5/02; G06F 15/18; G06F 17/30

(52) U.S. Cl. 706/12; 706/52; 707/723; 706/45; 707/E17.044

(57) ABSTRACT

An apparatus for modelling layers in a music signal comprises a rhythm modelling module configured to model rhythm features of the music signal; a harmony modelling module configured to model harmony features of the music signal; and a music region modelling module configured to model music region features from the music signal.

The invention relates to an apparatus and method for modelling layers in a music signal. The invention also relates to an apparatus and method for modelling chords of a music signal. The invention also relates to an apparatus and method for modelling music region content of a music signal. The invention also relates to an apparatus and method for tokenizing a segmented music signal. The invention also relates to an apparatus and method for deriving a vector for a frame of a tokenized music signal. The invention also relates to an apparatus and method for determining a similarity between a query music segment and a stored music segment.

In recent years, increasingly powerful technology has made it easier to compress, distribute and store digital media content. There is an increasing demand for the development of tools for automatic indexing and retrieval of music recordings. One task of music retrieval is to rank a collection of music signals according to the relevance to a query of each of the music signals. One format of music in a music information retrieval (MIR) application for popular songs is a raw audio format. The challenges of a MIR system include effective indexing of music information that supports run-time quick search, accurate query representation as the music descriptor, and robust retrieval modelling that rank the music database by relevance score.

Many MIR systems have been reported; two such examples are references [1][2]. The MIR communities initially focused on developing text-based MIR systems where both database music and the music query portions were in MIDI format and the information was retrieved by matching the melody of the query portion with the database portions as in, for example, references [5][6][7][11][24]. Since the melody information of both query portions and song database portions are text based (MIDI), efforts in this area were devoted to database organization of the music information (monophonic and/or polyphonic nature) and to text-based retrieval models. The retrieval models in those systems included dynamic programming (DP) [8][12][24], n-gram-based matching [6][11] [24].

Recently, with the advances in information technologies, the MIR community has started looking into developing MIR systems for music in raw audio format. One popular example of such systems are the query-by-humming systems [5][12], which allow a user to input the query by humming a melody line via the microphone. To do so, research efforts have been made to extract the pitch contours from the hummed audio, and to build a retrieval model that measures the relevance between the pitch contour of the query and the melody contours of the intended music signals. Autocorrelation [5], harmonic analysis [12] and statistical modelling via audio feature extraction [13] are some of the techniques that have been employed for extracting pitch contour from hummed queries. In [4][9][10], fixed length audio segmentation, spectral and pitch contour sensitive features are discussed to measure similarity between music clips.

However, the melody-based retrieval model is insufficient for MIR because it is highly possible that different songs share an identical melody contour. Hitherto, existing MIR systems simply have not addressed this and other issues.

The invention is defined in the independent claims. Some optional features of the invention are defined in the dependent claims.

A system in accordance with one or more of the independent claims provides a novel framework for music content indexing and retrieval. In this framework, a piece of music, such as a popular song can be characterised by layered music structure information including: timing, harmony/melody and music region content. These properties will be discussed in more detail below. Such a system uses, for example, chord and acoustic events in layered music information as the indexing terms to model the piece of music in vector space.

In general a system in accordance with one or more of the independent claims may provide musicians and scholars tools that search and study different musical pieces of similar music structures (rhythmic structure, melody/harmony structure, music descriptions, etc); help entertainment service providers index and retrieve the songs of similar tone and semantics in response to the user queries which are in the form of music clips, referred to as query-by-example.

The present invention will now be described, by way of example only, and with reference to the accompanying drawings in which:

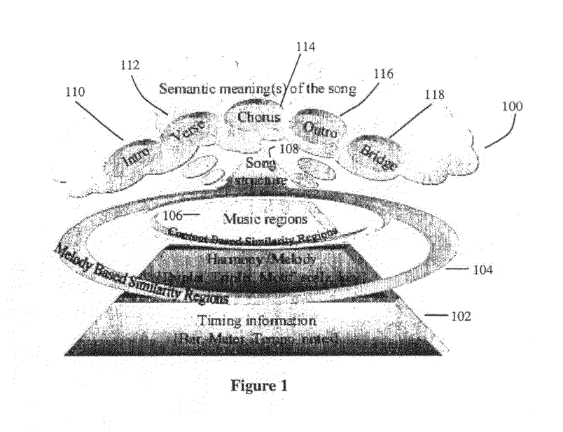

FIG. 1 is a diagram illustrating a novel framework of a music signal in multiple layers;

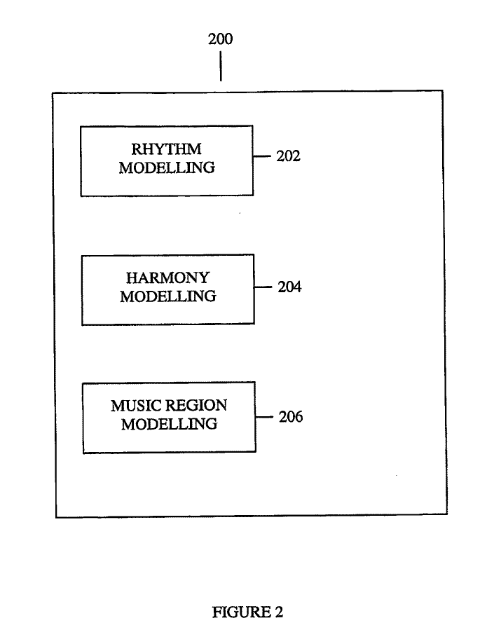

FIG. 2 is a block diagram illustrating an architecture for an apparatus for modelling layers in a music signal;

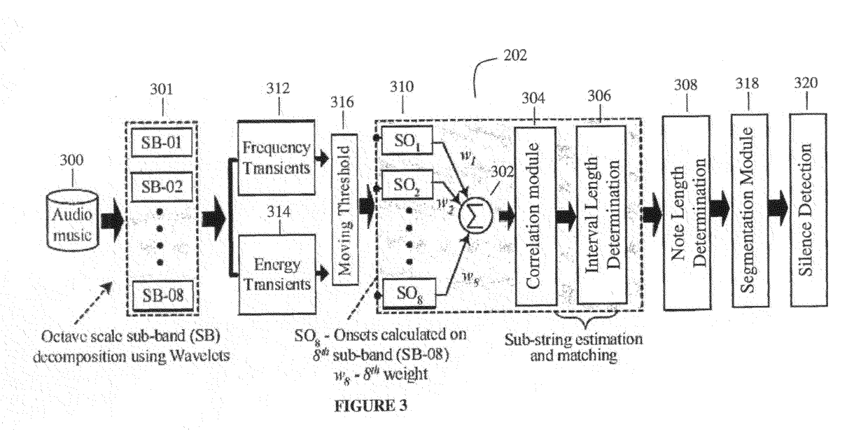

FIG. 3 is a block diagram illustrating an architecture and process flow for an apparatus for determining a smallest note length of a music signal;

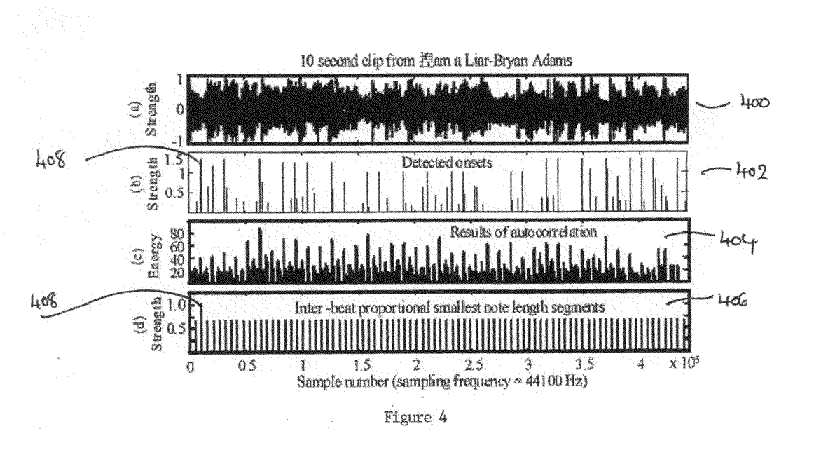

FIG. 4 is a block diagram illustrating output signals at different check points in the process of FIG. 3;

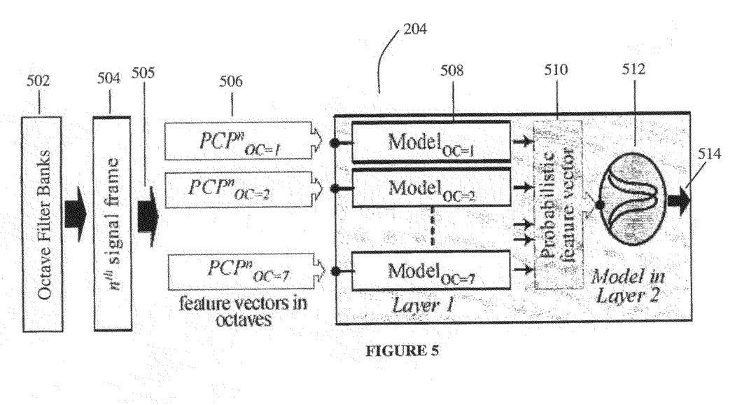

FIG. 5 is a block diagram illustrating an architecture and process flow for an apparatus for modelling chords of a music signal;

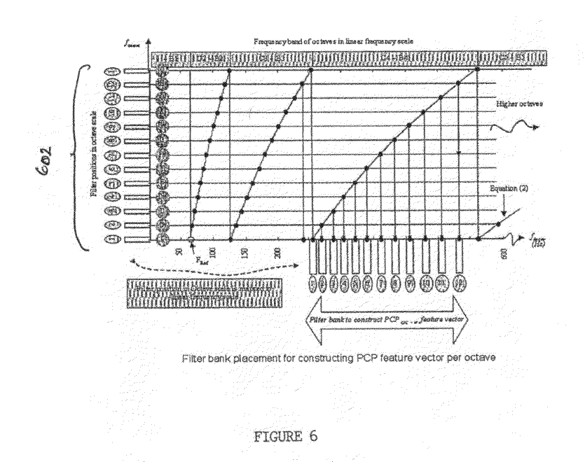

FIG. 6 is a diagram illustrating a transformation of octave scale filter positions to linear frequency scale as used in the apparatus of FIG. 5;

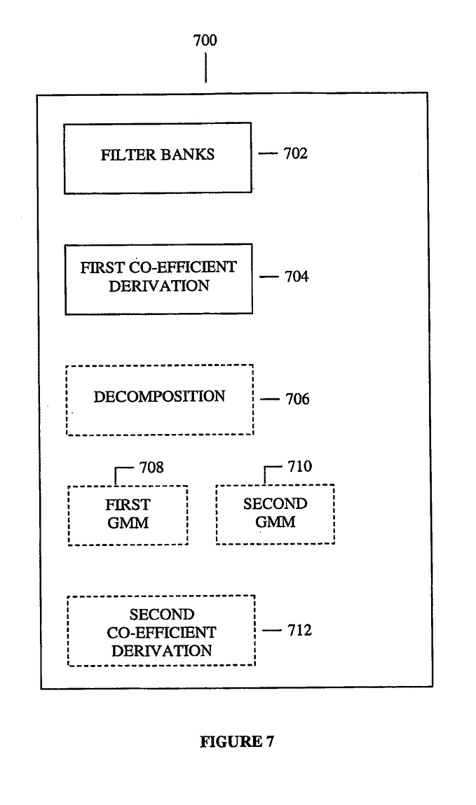

FIG. 7 is a block diagram illustrating an architecture of an apparatus for modelling music region content of a segmented music signal;

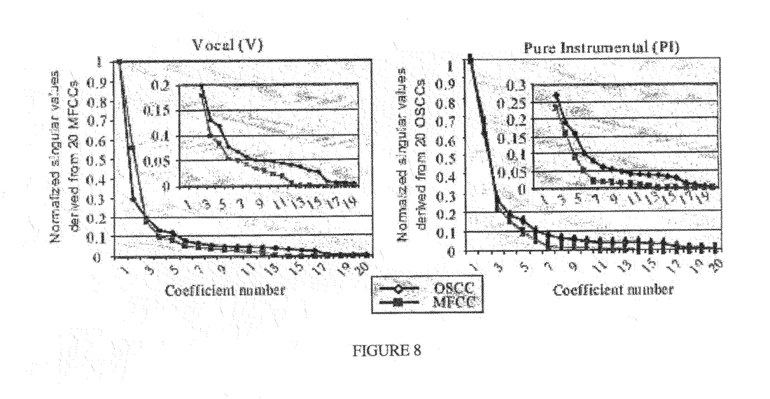

FIG. 8 is a graph illustrating singular values from OSCCs and MFCCs for PV and PI frames;

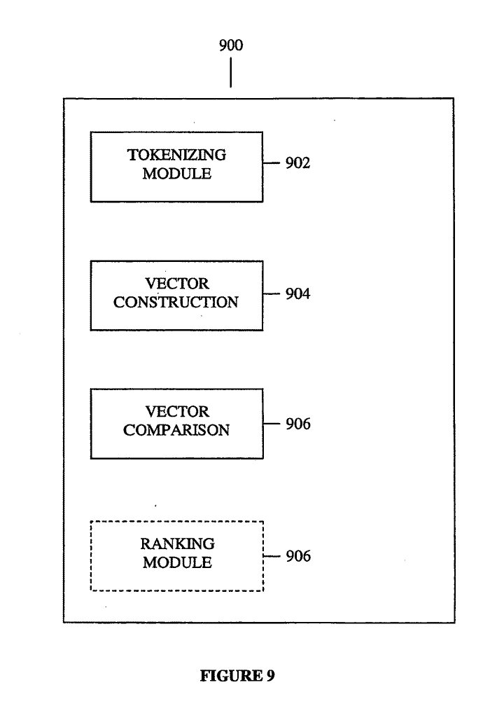

FIG. 9 is a block diagram illustrating an apparatus for tokenising a segmented music signal, constructing a vector for a frame of a tokenised music signal, and determining a similarity between a query music segment and a stored music segment;

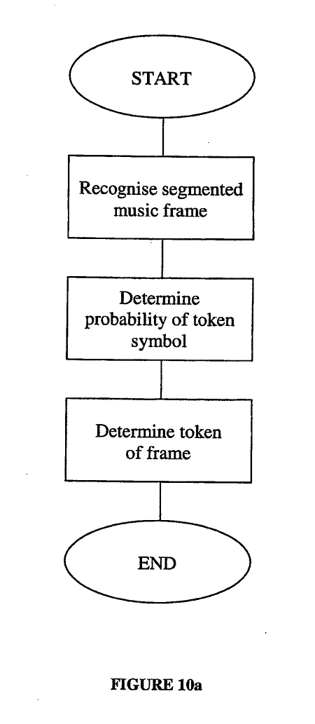

FIG. 10 is a block diagram illustrating a process flow of a tokenisation process for the apparatus of FIG. 9;

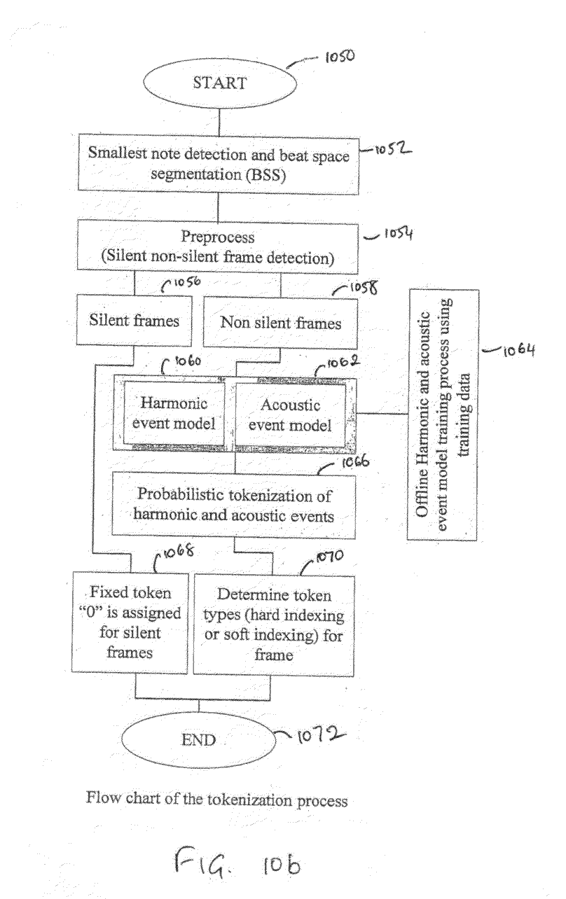

FIG. 11 is a diagram illustrating a vector representation of a music frame;

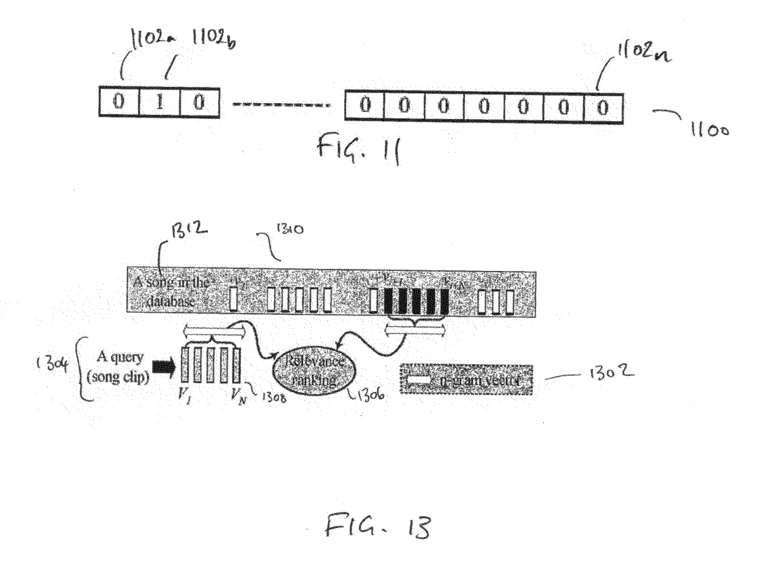

FIG. 12 is a diagram illustrating a second vector representation of a music frame;

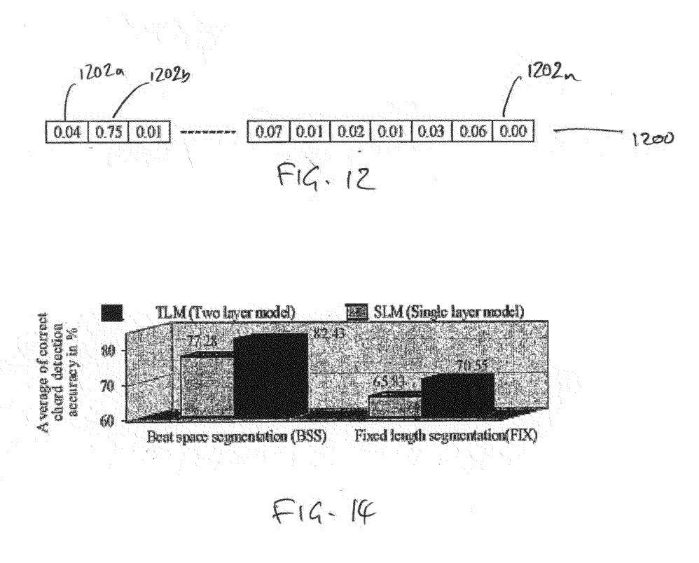

FIG. 13 is a block diagram illustrating the comparison of a query music segment and a stored music segment using the apparatus of FIG. 9;

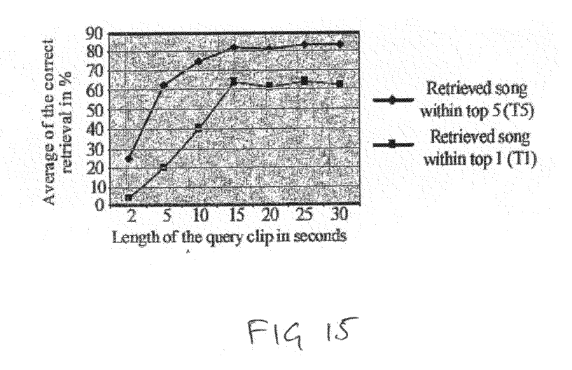

FIG. 14 is a bar chart illustrating average correct chord detection accuracy;

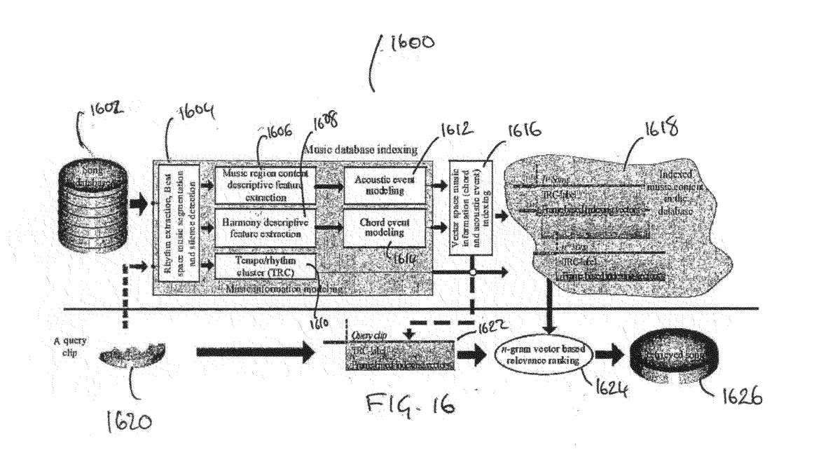

FIG. 15 is a chart illustrating the average retrieval accuracy of songs;

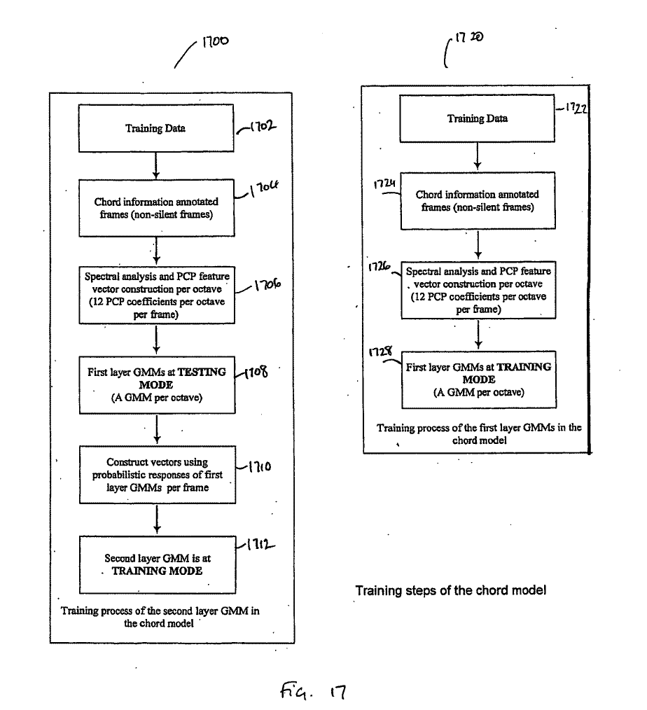

FIG. 16 is a block diagram illustrating a more detailed view of the apparatus of FIG. 2;

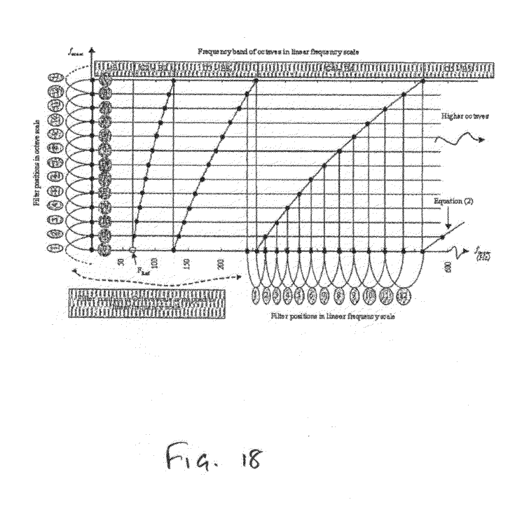

FIG. 17 is a flow diagram illustrating training steps of the chord model of FIG. 5;

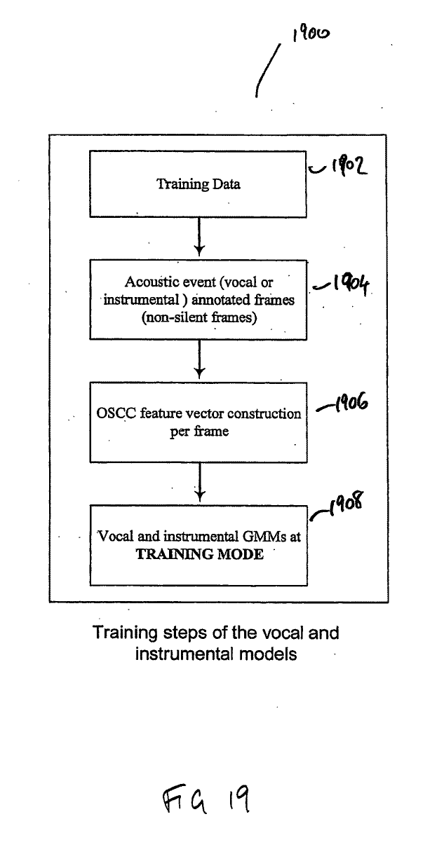

FIG. 18 is a diagram illustrating a transformation of octave scale filter positions to linear frequency scale for computation of OSCC feature which is used for vocal and instrumental information modelling to describe the acoustic event; and

FIG. 19 is a flow diagram illustrating the training steps of the first and second GMMs of FIG. 7.

A challenge for MIR of music in raw audio format, addressed by the techniques disclosed herein, is to represent the music content including harmony/melody, vocal and song structure information holistically. FIG. 1 illustrates that the disclosed techniques provides a novel framework for music.

The framework 100 of FIG. 1 decomposes a music signal in a multi-layer representation:
at a first level 102, timing data of the song is extracted from the music signal with a music segmentation process, referred to as a “beat space segmentation”. This process determines a smallest note length of the music signal and is discussed in greater detail with reference to FIG. 3.
at a second, higher, level 104, “chord events” are modelled and derived to capture the harmony information. This process is discussed in greater detail with reference FIG. 5.
at a third, yet higher level 106, the content of music regions is captured. This process is discussed with reference to FIG. 7.
the fourth, yet highest, level, 108, can be considered the structure level, within which the other three layers 102, 104, 106 can be considered to fall within. The song structure is defined by semantic meaning of the song: the intro 110, verse 112, chorus 114, outro 116 and bridge 118.

The first layer 102 is the foundation of the pyramidal music structure of FIG. 1. It is the layer which dictates the timing of a music signal. When time proceeds mixing multiple notes together in the polyphonic music, a harmony line is created, thereby providing the second layer 104 of music information. Pure instrumental (PI), pure vocal (PV), instrumental mixed vocal (IMV) and silence (S), comprising the third layer 106, are the music regions that can be seen in music. PV regions are rare in popular music. Silence regions (S) are the regions which have imperceptible music including unnoticeable noise and very short clicks. The contents of the music regions are represented in the third layer 106. The fourth layer 108 and above depicts the semantics of the song structure, which describes the events or the messages to the audience. Out of all the layers, the most difficult task is to understand the information in the top layer, the semantic meaning of a song from the song structure point of view. In the case of query-by-example MIR, a partial music segment is often used as a query instead of a full-length piece of music. It has been found that the lower layer music information is more informative than the top layer as far as MIR is concerned.

It is noted that popular songs are similar in many ways, for example, they may have a similar beat cycle—common beat patterns, similar harmony/melody—common chord patterns, similar vocal—similar lyrics and similar semantic content—music pieces or excerpts that creates similar auditory scenes or sensation. Using the musical structure of FIG. 1, a retrieval model is provided that evaluates the song similarities in the aspects of beat pattern, melody pattern and vocal pattern.

Musical signals representing songs/pieces of music are indexed in a database using vectors of the event models in layers 102, 104, 106. The retrieval process is implemented using vectors of n-gram statistics of the vectors of these layers of a query music segment. An overall architecture for an apparatus for modelling layers in a music signal is illustrated in FIG. 2.

FIG. 2 illustrates an apparatus 200 for modelling layers in a music signal. The apparatus 200 comprises rhythm modelling module 202 which is configured to model rhythm features of the music signal. The rhythm features of the music signal are those features illustrated in layer 102 of FIG. 1 and comprises the timing information such as the bar, the meter, the tempo, note duration and silence of the music signal. Harmony modelling module 204 is configured to model harmony features of the music signal. These harmony model features are those features in layer 104 of FIG. 1 and include the harmony and melody of the signal and features including duplet, triplet, motif, scale and key. Music region modelling module 206 is configured to model music region features from the music signal (layer 106 of FIG. 1) such as pure instrumental (PI), pure vocal (PV), instrumental mixed vocal (IMV) regions and phonetics of the music signal.

A more detailed description of rhythm modelling module 202 of FIG. 2 is now given in FIG. 3. The rhythm modelling module 202 may also be implemented as a stand-alone apparatus. Apparatus 202 is an apparatus for determining a smallest note length of the music. The apparatus 202 comprises a summation module 302 configured to derive a composite onset of the music signal from a weighted summation of octave sub-band onsets of the music signal. The octave sub-band onsets are mentioned below. Apparatus 202 also comprises an autocorrelation module 304 configured to perform an autocorrelation of the composite onset of the music signal thereby to derive an estimated inter-beat proportional note length. In one configuration, the autocorrelation module 304 performs a circular autocorrelation of the composite onset. Interval length determination module 306 determines a repeating interval length between dominant onsets when the estimated inter-beat proportional note length is varied. In tandem, modules 304, 306 provide sub-string estimation and matching. Note length determination module 308 determines a smallest note length from the repeating interval lengths. The apparatus also comprises the octave sub-band onset determination modules 310 which determine the octave sub-band onsets of the music signal from a frequency transient analysis and an energy transient analysis of a decomposed version of the music signal. The frequency transient analysis is carried out by frequency transient module 312. The energy transient analysis is carried out by energy transient modules 314. In one implementation, a moving threshold of the frequency transient and energy transient is calculated in moving threshold module 316. The moving threshold operation is applied to all the sub-bands after the frequency and energy transients modules 312, 314 perform their calculations. First, moving threshold module 316 normalises the outputs of transient calculation stages 312, 316 and removes detected transients below a certain threshold; in the present implementation, the threshold is set to 0.1 on the normalised scale. Then module 316 performs a running calculation over a window of 90 ms (1.5 times the frame size of 60 msecs) and selects the highest transient impulse within the window as a possible candidate of a sub-band onset.

In one implementation, the frequency transient analysis module 312 performs frequency transient analysis for the first to the fourth octave sub-bands. The reason for this is discussed below. In one implementation, the energy transient analysis module 314 performs energy transient analysis for the fifth to eighth octave sub-band. Again, the reason for this is discussed below. Apparatus 202 also comprises a segmentation module 318 for deriving a frame of the music signal. The music signal frame has a length corresponding to the smallest note length. The segmentation module 318 also designates a reference point in the music signal corresponding to a first dominant onset of the music signal.

Apparatus 202 also comprises a tempo rhythm cluster (TRC) module (not shown) which derives a tempo rhythm cluster of the music signal from the smallest note length and multiples thereof. The inventors have found that tempo of pieces of popular music usually have a tempo of 60 to 200 BPM (beats per minute). In one implementation, this range is divided into steps of 20 BPM clusters. Thus songs of 60-80 BPM are grouped into a corresponding cluster 1. Cluster 2 is a group of songs with tempo in the range of 81-100 BPM and so on. For a given query clip, the clip's tempo is computed after detection of the smallest note length.

Then the search space pointer is set not only to the cluster which the query tempo fall in but also to the clusters where integer multiples of query tempo falls in. This is discussed in more detail below with respect to FIG. 13.

Additionally, apparatus 202 comprises a silence detection module 320 for detecting that a frame of the music signal is a silent frame from a short-time energy calculation of the frame. Alternatively, silence detection module 320 is provided as a separate module distinct from apparatus 202. After apparatus 202 segments the music into smallest note size signal frames, silence detection module 320 performs a calculation of short time energy (STE) such as in, say, [14], for the or each frame of the music signal. If the normalised STE is below a predefined threshold (say, less than 0.1 on the normalised scale), then that frame is denoted a silent (S) frame and is then excluded from any of the processing of the music signal described below. This may done by, for example, tokenizing module 902 of FIG. 9 assigning a fixed token of ‘0’ (zero) to the silent frame in the tokenization process of FIG. 10.

The fundamental step for audio content analysis is the signal segmentation where the signal within a frame can be considered as quasi-stationary. With quasi-stationary music frames, apparatus 202 extracts features to describe the content and model the features with statistical techniques. The adequacy of the signal segmentation has an impact on system level performance of music information extraction, modelling and retrieval.

Earlier music content analysis [4][9][10] approaches use fixed length signal segmentation only.

A music note can be considered as the smallest measuring unit of the music flow. Usually smaller notes (⅛, 1/16 or 1/32 notes) are played by one or more musicians in the bars to align the melody with the rhythm of the lyrics and to fill in the gap between lyrics. Therefore the information within the duration of a music note can be considered quasi-stationary. The disclosed techniques segment a music signal into frames of the smallest note length instead of fixed length frames as has been done previously. Since the inter-beat interval of a song is equal to the integer multiples of the smallest note, this music framing strategy is called Beat Space Segmentation (BSS). BSS captures the timing (rhythm) information (the first structural layer of FIG. 1) of the music signal.

BSS provides a means to detect music onsets and perform the smallest note length calculation. FIG. 3 illustrates one apparatus for this purpose. As highlighted in [15] that the spectral characteristics of the music signals comprise envelopes proportional to octaves, the apparatus 202 of FIG. 3 first decomposes the audio music signal 300 into 8 sub-bands using wavelets by modules 301 whose frequency ranges are shown in Table 1.

Apparatus 202 then segments the sub-band signals into 60 ms with 50% overlapping. Both the frequency and energy transients are analyzed using a similar method to that in [20]. Frequency transient analysis module 312 measures the frequency transients in terms of progressive distances in octave sub-bands 01 to 04 because fundamental frequencies (F0s) and harmonics of music notes in popular music are strong in these sub-bands. Energy transient analysis module measures the energy transients in sub-band 05 to 08 as the energy transients are found to be stronger in these sub-bands.

Equation 1 describes the computation of final (dominant) onset at time ‘t’, On(t) which is the weighted summation of sub-band onsets SOᵣ(t).

On(t)=Σᵣ₌₁⁸w(r)·SOᵣ(t) (1)

The output of moving threshold calculation module 316 is supplied to the octave sub-band onset determination modules 310. Summation module 302 derives a composite onset of the music signal from a weighted summation of octave sub-band onsets of the music signal output by modules 310. It has been found that the weights, w₁, w₂, . . . , wₙ of weighted matrix w having matrix elements {0.6, 0.9, 0.7, 0.9, 0.7, 0.5, 0.8, 0.6} provides the best set of weightings for calculating the dominant onsets in the music signal.

The output of summation module 302 is supplied to autocorrelation module 304 where an autocorrelation of the composite onset is performed to derive an estimated inter-beat proportional note length. Interval length determination module 304 varies this estimated note length to check for patterns of equally spaced intervals between dominant onsets On(.). In one implementation, the interval length determination module uses a dynamic programming module using known dynamic programming techniques to check for these patterns. A repeating interval length—perhaps the most popularly found or common smallest interval which is also integer fractions of other longer intervals—is taken as the smallest note length by note length determination module 308. A segmentation module 318 is provided to segment the music signal into one or more music frames according to the smallest note length. Segmentation module 318 also designates a reference point in the music signal corresponding to a first dominant onset of the music signal as determined by summation module 302.

The processing of the music signal is illustrated with reference to FIG. 4. FIG. 4(a) illustrates a 10-second song clip 400. The dominant onsets 402 detected by summation module 302 are shown in FIG. 4(b). The output 404 of correlation module 304, an autocorrelation of the detected onsets, is shown in FIG. 4(c). Inter-beat proportional smallest note level 406 measure is shown in FIG. 4(d). In the example of FIG. 4, the 10-second song clip 400 is an extract of the song I am a liar, by the musician Bryan Adams. The inter-beat proportional smallest note length 406 of this clip is determined to be 183.11 ms by the apparatus 202 of FIG. 3. This smallest note-length duration is determined to be the “beat” or “tempo” of the song.

In the apparatus 202, an assumption is made that the tempo of the song is constant. Therefore the starting point of the song is used as the reference point for BSS. This is illustrated in FIGS. 4(b) and (d) at point 408. Similar steps are followed for computation of the smallest note length of the query song clip (the process of comparison of the query song clip with the stored song clips is discussed in greater detail below.) However the first dominant onset is used as the reference point to segment the clip back and forth accordingly.

The smallest note length and its multiples form the tempo/rhythm cluster (TRC). By comparing the TRC of query clip with TRC of the songs in the database we narrow down the search space.

Silence is defined as a segment of imperceptible music, including unnoticeable noise and very short clicks. Apparatus 202 calculates the short-time energy function to detect the silent frames.

Referring again to FIG. 2, it will be recalled that apparatus 200 comprises a harmony modelling module 204. Harmony modelling module 204 enables an analysis of the harmony of the music signal. Harmony modelling module 204 may be provided as a stand-alone apparatus.

The progression of music chords describes the harmony of music. A chord is constructed by playing set of notes (>2) simultaneously. Typically there are 4 chord types (Major, Minor, Diminish and Augmented) and 12 chords per chord type that can be found in western music. For efficient chord detection, the tonal characteristics (the fundamental frequencies—F0s, the harmonics and the sub-harmonics) of the music notes which comprise a chord should be well characterized by the feature. Goldstein (1973) [17] and Terhardt (1974) [18] proposed two psycho-acoustical approaches: harmonic representation and sub-harmonic representation, for complex tones respectively. It is noted that harmonics and sub-harmonics of a music note are closely related with the F0 of another note. For example, the third and sixth harmonics of note C4 are close to (related to) the fundamental frequencies F0 of G5 and G6. Similarly the fifth and seventh sub-harmonics of note E7 are closed to F0 of C5 and F#4 respectively.

A more detailed view of the harmony modelling module 204 of FIG. 1 is an apparatus for modelling chords in a music signal which is now described with respect to FIG. 5. FIG. 5 illustrates in more detail apparatus module 204 of FIG. 2.

Referring to FIG. 5, an apparatus 204 for modelling chords of a music signal is now described. The apparatus comprises octave filter banks 502 for receiving a music signal segmented into frames and extracting plural characteristics of musical notes and frames as will be discussed below. The n^{th} signal frame 504 is output in segmented form from the octave filter banks 502. Vector construction module 506 (shown as individual modules for each octave in FIG. 5) constructs pitch class profile vectors from the input tonal characteristic 505. A first layer model 508 is trained by the pitch class profile vectors and output in turn as probabilistic feature vectors 510 which are used to train the second layer module 512 thereby to model chords 514 of the music signal. The octave filter banks 502 comprise twelve filters centred on respective fundamental frequencies of respective notes in each octave. Each filter in the octave filter banks 502 is configured to capture strengths of the fundamental frequencies of its respective note and sub-harmonics and harmonics of related notes. The vector construction module 506 derives an element of a pitch class profile vector from a sum of strengths (e.g. sums of spectral components) of a note of the frame and strengths of sub-harmonics and harmonics of related notes.

In the chord modelling/detection system of FIG. 5, 12 filters centred on the fundamental frequencies of 12 notes in each octave covering 8 octaves (C2B2˜C8B8) capture the strengths (i.e. of the spectrum magnitudes) of the F0s of the notes, and the sub-harmonics and harmonics of related notes (please see FIG. 6 for filter placement positions 602 in octave scale). The filter positions are calculated using Eq (2) which first maps the linear frequency scale (fₗᵢₙₑₐᵣ) into octave scale (f_{octave}) where Fs, N, F_{req} are sampling frequency, number of FFT points and reference mapping point respectively. The frequency resolution (Fs/N) is set to equal 1 Hz, F_{req}=64 Hz (F0 of the note C2) and C=12 (12 pitches).

$${f}_{Octave} = [ C * {log}_{2} ( \frac{Fs * {f}_{linear}}{N * {F}_{ref}} ) mod C ] \qquad ( 2 )$$

The reasons for using filters to extract tonal characteristics of notes are primarily two-fold:
Due to physical configuration of the instruments, the F0s of the notes may vary from the standard values (A4=440 Hz is used as the concert pitch).
Though the physical octave ratio is 2:1, cognitive experiments have highlighted that this ratio is close at lower frequencies, but increases with the higher frequencies. It exceeds by 3% at about 2 kHz [19]. Therefore, the filters are position to detect the strengths of the harmonics of the shifted notes.

It has been found that the tonal characteristics in an individual octave can effectively represent the music chord. The two-layer hierarchical model for music chord modelling of FIG. 5 models these chords (the training process of a chord model is discussed in FIG. 17). The first layer model 508 is trained using twelve-dimensional (one for each note) pitch class profile (PCP) feature vectors 506 which are extracted from the individual octaves. It has been found that better chord detection accuracy is found primarily in chords C2B2˜C8B8 octaves and, therefore, in one implementation the C9B9 octave is not considered; that is, seven octaves are considered. The construction of the PCP vector 506 for the n^{th} signal frame and for each octave is defined by Equation 3 below. The F0 strengths of the α^{th} note and related harmonic and sub-harmonic strengths of other notes are summed up to form the α^{th} coefficient of the PCP vector. In Equation 3, S(.) is the frequency domain magnitude (in dB) signal spectrum.

PCP_{OC}ⁿ(α)=[S(.)W_{(OC,α)}]² OC=1 . . . 7, α=1 . . . 12. (3)

W_{(OC, α)} is the filter whose position and the pass-band frequency range varies with both octave index (OC) and α^{th} note in the octave (OC). If the octave index is 1, then the respective octave is C2B2.

Seven respective statistical models 508 are trained with the PCP vectors 506 in the first layer of the model using the training data set. Then the same training data is fed to first layer as test data and store in a memory (not shown) the outputs given by the seven models 508 in the first layer. Seven multi-dimensional probabilistic vectors 510 are constructed from the outputs of the layer one models 508 which are then used to train the second layer model 512 of the chord model.

That is, the second layer model 512 is trained with probabilistic feature vector outputs 510 of the first layer models 508. In one implementation, four Gaussian mixtures models are used for each model in the first and second layers 508, 512. This two-layer modelling can be visualized as first transforming feature space represented tonal characteristics of the music chord into probabilistic space at the first layer 508 and then modelling them at the second layer 512. This two-layer representation is able to model 48 music chords in the chord detection system 204 of FIG. 5.

FIG. 17 provides a more detailed view of the process conducted in FIG. 5 and illustrates first a training process 1700 of the second layer GMM in the chord model. Initially, training data is processed 1702 to provide manually annotated chord information frames for non-silent frames at step 1704. At step 1706, spectral analysis and PCP vector construction is carried out by octave to provide 12 PCP coefficients per octave per frame. These provide the vectors 506 of FIG. 5. At step 1708, the first layer GMMs 508 are trained, one GMM per octave, to construct vectors using probabilistic responses of the first layer GMMs 508 per frame at step 1710. This provides the probabilistic vectors 510 of FIG. 5. At step 1712, the second layer GMM (model 512 of FIG. 5) is trained with the probabilistic vectors 510 of FIG. 5.

The training process 1720 of the first layer GMMs 508 is also illustrated in FIG. 17. This provides a more detailed view of step 1708. Training data is processed 1722 to provide manually annotated chord information frames for non-silent frames at step 1724. At step 1726, spectral analysis and PCP vector construction is carried out per octave to provide 12 PCP coefficients per octave per frame to train the first layer model 508 at step 1728.

As discussed above, PV, PI, IMV and S are the regions that can be seen in a song (third layer 106 of FIG. 1). However PV regions are comparatively rare in popular music. Therefore both PV and IMV regions are considered in combination as a vocal (V) region. The modelling of the contents of three regions (PI, V and S) in this layer 106 is now discussed. Silence detection has already been discussed with respect to FIG. 3.

An apparatus 700 for modelling of music region content of layer three of FIG. 1 is illustrated with respect to FIG. 7. This illustrates music region modelling module 206 of FIG. 2, which may alternatively be provided as a stand-alone apparatus.

The apparatus comprises, principally, octave scale filter banks (the octave scale/frequency transformation of which is illustrated in FIG. 18) 702 which receive a frame of a segmented music signal and derive a frequency response thereof. Apparatus 700 also comprises a first coefficient derivation module 702 which derives octave cepstral coefficients of the music signal from the frequency response of the octave filter banks and derives feature matrices comprising octave cepstral coefficients of the music signal for music regions.

Optionally, apparatus 700 also includes first and second gaussian mixture modules 708, 710 which are trained by the OSCC feature vector construction per frame for use in the tokenization process described below with respect to FIGS. 9 and 10. As a further option, apparatus 700 also has a second coefficient derivation module 712 which derives mel frequency cepstral coefficients of the segmented music signal. These may also be used for training the models 708, 712. As a yet further option, apparatus 700 also comprises a decomposition module 706 to perform singular value decomposition, used as a tool to compare the correlation of the coefficients of OSCC feature and MFCC feature. It is found—as discussed with respect to FIG. 8—that singular values are higher for OSCC than for MFCC, illustrating OSCCs are less correlated compared to MFCCs. When feature coefficients are less correlated, then the information modelling is more accurate.

A sung vocal line carries more descriptive information about the song than other regions. In the PI regions, extracted features must be able to capture the information generated by lead instruments which typically defines the tunes/melody. To this end, the apparatus of FIG. 7 examines Octave scale cepstral coefficient (OSCC) features and Mel-frequency cepstral coefficient (MFCC) feature for their capabilities to characterise music region content information. MFCCs have been highly effective characterising the subjective pitch and the frequency spectrum of speech signals [14]. OSCCs are computed by using a filter bank in the frequency domain. Filter positions in the linear frequency scale (fₗᵢₙₑₐᵣ) are computed by transforming linearly positioned filters in the octave scale (f_{octave}) to fₗᵢₙₑₐᵣ using Equation 2 already discussed above and illustrated in FIG. 18. In the apparatus of FIG. 7, the parameters of Equation 2 are set as follows: C=12, F_{ref}=64 Hz so that 12 overlapping rectangular filters are positioned in each octave from C2B2 to C9B9 octave (64˜16384) Hz. The hamming shape of filter/window has sharp attenuation and it suppresses valuable information in the higher frequencies by almost three-fold more than rectangular-shaped filters [14]. Therefore rectangular filter may be used in the apparatus of FIG. 7 in preference to hamming filters for music signal analysis because music signals are wide band signals compared to speech signals.

The output Y(b) of the b^{th} filter is computed according to Equation 4 where S(.) is the frequency spectrum in decibel (dB), H_{b}(.) is the b^{th} filter, and m_{b} and n_{b} are boundaries of b^{th} filter.

$$Y ( b ) = {\sum }_{a = {m}_{b}}^{{n}_{b}} S ( a ) {H}_{b} ( a ) \qquad ( 4 )$$

Equation 5 describes the computation of β^{th} cepstral coefficient where k_{b}, N_{f} and Fn are the centre frequency of the b^{th} filter, number of frequency sampling points and number of filters respectively (Fn=12 in the present case).

$$C ( β ) = \frac{2}{β} {\sum }_{b = 1}^{Fn} Y ( b ) cos ( {k}_{b} \frac{2 π}{{N}_{f}} β ) \qquad ( 5 )$$

Singular values (SVs) indicate the variance of the corresponding structure. Comparatively high singular values of the diagonal matrix of the SVD process describe the number of dimensions with which the structure can be represented orthogonally. SVD is a technique for checking the level of the correlation among the feature coefficients for groups of information classes. Higher singular values in a diagonal matrix resulting from the decomposition illustrates the lesser correlation between the coefficients of a particular feature for an information class. If the feature coefficients are less correlated then the modelling of the information using that feature is more successful. That is, smaller singular values indicate the correlated information in the structure and considered to be noise. We perform singular value decomposition (SVD) over feature matrices extracted from PT and V regions with respect to the process 1900 of FIG. 19. Training data is taken at 1902 where time durations of V and PI regions are manually annotated in a listening process by a user at step 1904. OSCC feature vectors are constructed at step 1906 and the models 708 and 710 trained at step 1908 with the vectors from step 1906.

FIG. 8 shows the normalised singular value variation of 20 OSCCs and 20 MFCCs extracted from both PI and V regions of a Sri Lankan Song “Ma Bala Kale”. The frame size is a quarter note length (662 ms). The apparatus of FIG. 7 uses a total of 96 filters for calculating MFCCs and OSCCs. It can be seen that singular values of OSCCs are higher than of MFCCs for both PV and PI frame. The average of 20 singular values per OSCCs for PV and PI frames are 0.1294 and 0.1325. However, for MFCC, they are as low as 0.1181 and 0.1093 respectively.

As shown in FIG. 8, the singular values are in descending order with respect to the ascending coefficient numbers. The average of the last 10 singular values of OSCCs is nearly 10% higher than they are for MFCCs, which means the last 10 OSCCs are more uncorrelated than the last 10 coefficients of MFCCs. Thus we can conclude that the OSCCs represents contents in music regions more uncorrelated than MFCCs. As is known, the modelling results will provide better performance when the coefficient values are higher. Thus, the OSCC values provide better performance for modelling than MFCCs due to its higher uncorrelation.

An apparatus or apparatus module for tokenizing the music signal, constructing a vector of the tokenized music signal and comparing vectors of stored and query music segments is illustrated in FIG. 9. The apparatus 900 is usable as a stand-alone module or with the apparatus of any of FIG. 2, 3, 5 or 7. The apparatus comprises a tokenizing module 902, a vector construction module 904 and a vector comparison module 906. Alternatively, or additionally, the apparatus 900 also comprises a ranking module 908 described below. Note that these individual modules 902, 904, 906, 908 may be provided as separate modules or as one or more integrated module.

Vector space modelling has been used previously in, for example, text document analysis. It has not hitherto been used in music signal analysis. Perhaps the principal reason for this is that, unlike modelling of text documents that uses words or phrases as indexing terms, a music signal is a running digital signal without obvious anchors for indexing. Thus, the primary challenges for indexing music signals are two-fold. First, good indexing anchors must be determined. Secondly a good representation of music contents for search and retrieval must be derived. Apparatus for tokenizing the music signal and an apparatus for deriving a vector representation of the music signal again makes use of the multi-layer model of FIG. 1. The layer-wise representation allows us to describe a music signal quantitatively in a descriptive data structure. Next, we will propose the indexing terms for music signals.

As discussed above with respect to FIG. 5, a two-layer hierarchical harmony model and the extraction of sub-band PCP features is disclosed. A harmony model describes a chord event. Note that it is relatively easy to detect beat placing in a music signal. A beat space is a natural choice as a music frame, and thus the indexing resolution of a music signal.

In general terms, an apparatus for tokenizing the music signal—that is, deriving the “vocabulary” of the song for vector representation of the song—comprises a tokenizing module 902 to receive a frame of a segmented music signal (segmented by the apparatus of FIG. 3), to determine a probability the frame of the music signal corresponds with a token symbol of a token library, and to determine a token for the frame accordingly. An overview of the tokenizing process flow is illustrated in FIG. 10a. Two types of tokens are proposed: a chord event from the second layer 104 of FIG. 1 and an acoustic event from third layer 106 of FIG. 1. In the determination of the probability the frame of the music signal corresponds with a token symbol (e.g. a chord event) of a token library (e.g. the chord model of FIG. 5), both hard indexing and soft indexing systems are provided, as discussed below.

In one implementation, the token symbol comprises a chord event and the token library comprises a library of modelled chords, the tokenizing module being configured to determine a probability the frame of the music signal corresponds with a chord event.

Suppose an apparatus comprises 48 trained frame-based chord models 508, 512 as shown in FIG. 5 (four chord types Major, Minor, Diminish and Augmented in combination with 12 chords each type). Each chord model describes a frame-based chord event which can serve as the indexing term. One can think of music as a chord sequence, with each chord spanning over multiple frames. A chord model space A={Cᵢ} can be trained on a collection of chord-labelled data. It has been found the HTK 3.3 toolbox for training such a two-layer chord model space. At run-time, a music frame Oₙ is recognized and converted to a chord event Î_{c} in accordance with Equation 6. That is, tokenizing module 902 determines that the frame Oₙ corresponds with a chord event of the chord model space (the token symbol of the token library). Thus, the music signal is therefore tokenized into a chord event sequence by the tokenizing module 902 in accordance with Equation 6.

$${\hat{I}}_{c} = arg {max}_{c} p ( {o}_{n} \vert {c}_{i} ) \\ i = 1 , … , 48 \qquad ( 6 )$$

The chord events represent the harmony of music. Note that a music signal is characterised by both harmony sequence and the vocal/instrumental patterns. To describe the music content, the vocal and instrumental events of third layer 106 are defined. Thus, in one implementation, the token symbol comprises an acoustic event and the token library comprises a library of acoustic events, and the tokenizing module determines a probability the frame of the music signal corresponds with an acoustic event. The acoustic event may comprise at least one of a voice event or an instrumental event.

Pure instrumental (PI) and the vocal (V) regions contain the descriptive information about the music content of a song. A song can be thought of as a sequence of interweaved PI and V events, called acoustic events. Two Gaussian Mixture models, GMMs (64 GMs in each) are trained to model each of them with the 20 OSCC features extracted from each frame described above with respect to the music region modelling apparatus of FIG. 7. The frame-based acoustic events are defined as another type of indexing/tokenizing term in parallel with chord events. Suppose there are terms r₁ for PI and r₂ for V events. These are trained from a labelled database. At run-time, a music frame Oₙ is recognized and converted to a V or PI event Îᵣ, and a music signal is therefore decoded into a vocal sequence. Eq. (6) and (7) can be seen as the chord and acoustic event decoders.

$${\hat{I}}_{r} = arg {max p}_{i = 1 , 2} ( {o}_{n} \vert {r}_{i} ) \qquad ( 7 )$$

The contents in silence regions (S) are indexed with zero observation. Thus, the disclosed techniques use the events as indexing terms to design a vector for a music segment.

The chord and acoustic decoders serve as the tokenizers for music signal. The tokenization process results in two synchronized streams of events, a chord and an acoustic sequence, for each music signal. An event is represented by a tokenization symbol. They are represented in text-like format. It is noted that n-gram statistics has been used in natural language processing tasks to capture short-term substring constraints such as letter n-gram in language identification [22] and spoken language identification [23]. If one thinks of the chord and acoustic tokens, as the letters of music, then a music signal is an article of chord/acoustic transcripts. Similar to the letter n-gram in text, it has been found it is possible to use the token n-gram of music as the indexing terms, which aims at capturing the short-term syntax of musical signal. The statistics of tokens themselves represent the token unigram. Thus, a vector defining a music segment (which can be a music frame or multiple thereof) can be derived. Thus, an apparatus for deriving a vector for a frame of a tokenized music signal comprises a vector construction module configured to construct a vector having a vector element defining a token symbol (e.g. a chord or an acoustic event) score for the frame of the tokenized music signal.

A more detailed view of the tokenization process is illustrated in FIG. 10b. The process starts at step 1050 and the beat space segmentation 1052 and silent frame detection 1054 are performed as described above, resulting in identification of silent frames at step 1056 and the non-silent frames at step 1058. The silent frames are then assigned a fixed token of ‘0’ at step 1068 and excluded from further processing. The non-silent frames are then applied to the harmonic event model of FIG. 5 at step 1060 and the acoustic event model of FIG. 7 at step 1062. The harmonic and acoustic event model training processes of FIGS. 17 and 19 respectively are conducted offline at step 1064. Probabilistic tokenization is performed at step 1066 for the ith chord model of the second layer models 512 of FIG. 5. For the determination of the token type of chord events at step 1070, the token is given for the nth frame by the ith chord model. For probabilistic outputs of acoustic events at step 1066, two probabilistic outputs are provided from the vocal and instrumental GMMs 708, 710 of FIG. 7 before two tokens are given for the nth frame by the vocal and instrumental models at step 1070. The process ends at step 1072.

Vector space modelling (VSM) has become a standard tool in text-based IR systems since its introduction decades ago [21]. It uses a vector to represent a text document. One of the advantages of the method is that it makes partial matching possible. Known systems derive the distance between documents easily as long as the vector attributes are well defined characteristics of the documents. Each coordinate in the vector reflects the presence of the corresponding attribute, which is typically a term. The novel techniques disclosed herein define chord/acoustic tokens in a music signal. These are used as terms in an article. Thus it has been found that it is now possible to use a vector to represent a music segment. If a music segment is thought of as an article of chord/acoustic tokens, then the statistics of the presence of the tokens or token n-grams describe the content of the music. A vector construction module 904 constructs a vector having a vector element defining a token symbol score for the frame of the tokenized music signal.

Suppose a music token sequence, t₁t₂t₃t₄ is defined. The tokenizing module 902 derives the unigram statistics from the token sequence itself. Module 902 derives the bigram statistics from t₁(t₂) t₂(t₃) t₃(t₄) t₄(#) where the acoustic vocabulary is expanded over the token's right context. The # sign is a place holder for free context. In the interest of manageability, the present technique only use up to bigrams, but it is possible also to derive the trigram statistics from the t₁(#,t₂) t₂(t₁,t₃) t₃(t₂,t₄) t₄(t₃,#) to account for left and right contexts.

Thus, for an acoustic vocabulary of |c|=48 token entries in the chord stream, we have 48 unigram frequency items fₙⁱ in the chord vector \vec{f}ₙ={fₙ¹, . . . , fₙⁱ, . . . fₙ⁴⁸} as in FIG. 11. The vector 1100 of FIG. 11 is a chord unigram vector constructed by vector construction module 904 by a vector element defining a count that the frame comprises a token, such as a chord event or an acoustic event. The vector has a vector element defining a token symbol score for the frame of the tokenized music signal. In this implementation, vector element fₙⁱ is equal to 1, if tₙ=cᵢ otherwise its 0.

Referring to FIG. 11, the chord unigram vector 1100 comprises elements 1102a, 1102b, . . . , 1102n, where in this case n=48 corresponding to the 48 chords. Element 1102b has a “one” count, as it is determined that the chord vector for the n^{th} frame for which the vector is constructed comprises the chord corresponding to element 1102b. In this implementation, the vector element is defined as a binary score of whether the frame corresponds with the token symbol/chord event. Such a system defines a “hard-indexing” system.

Alternatively, the vector construction module defines the vector element(s) as a probability score of whether the frame corresponds with a token symbol (chord event). This is illustrated in FIG. 12 where, for example, the vector construction module 904 determines that a particular element 1202a of chord unigram vector 1200 comprises a 0.04 probability of being the chord element of the chord library corresponding with element 1202a. On the other hand, vector construction module determines there is a 0.75 probability that the frame corresponds with the chord event corresponding with element 1202b. In this implementation, the vector construction module determines that the vector element has a score between zero and unity. In one implementation, the vector construction module 904 defines the vector elements so that a sum of the vector elements within the vector is unity.

In the same way, vector construction module 904 constructs an acoustic vector of two unigram frequency items in the acoustic vector for the acoustic stream. For simplicity, the vector construction module 904 only formulates \vec{f}ₙ next.

To capture the short-term dynamics, the vector construction module is also configured to derive a bigram representation for two consecutive frames. As such, we build a chord bigram vector of [48×48=2304] dimensions, \vec{f}ₙ′={fₙ^{1,1}, . . . , fₙ^{i,j}, . . . , fₙ^{48,48}} where if both fₙ¹=1 and fₙ₊₁^{j}=1, then fₙ^{i,j}=1; otherwise fₙ^{i,j}=0. Similarly an acoustic bigram vector of [2×2=4] dimensions is formed.

Thus, for a music segment of N frames, a chord unigram vector \vec{f}_{N}={f_{N}¹, . . . , f_{N}ⁱ, . . . , f_{N}⁴⁸} is constructed by aggregating the frame vectors with the i^{th} element as

f_{N}ⁱ=Σₙ₌₁^{N}fₙⁱ (8)

The chord bigramvector of [48×48=2304] dimensions \vec{f}′_{N}={f_{N}^{1,1}, . . . , f_{N}^{i,j}, . . . , f_{N}^{48,48}} is constructed in a similar way with the element (i, j)^{th} as

f_{N}^{i,j}=Σₙ₌₁^{N}fₙ^{i,j} (9)

The acoustic vector can be formulated in a similar way with a two-dimensional vector for unigram and [2×2=4] dimensional vector for bigram.

The hard-indexing scheme above provides acceptable results. Although it would be convenient to derive the term count from token sequences of a query or a music segment, it is found that tokenization is affected by many factors. It does not always produce identical token sequence for two similar music segments. The difference could be due to the variation in beat detection, variation of music productions between the query and the intended music. The inconsistency between the tokenization of the query and the intended music present undesired mismatch as far as MIR is concerned. Assuming that the numbers of beats in query and music are detected correctly, the inconsistency is characterized by substitutions of tokens between the desired label and the tokenization results. If a token is substituted, then it presents a mismatch between the query and the intended music segment. To address this problem, the soft-indexing scheme uses the tokenizers as probabilistic machines that generate a posteriori probability for each of the chord and acoustic events. If we think of the n-gram counting as integer counting, then the posteriori probability can be seen as soft-hits of the events. In one implementation, the soft-hits are formulated for both the chord and acoustic vectors, although it possible to do this only for the chord vector. Thus, according to Bayes' rule, we have

$$p ( {c}_{i} \vert {o}_{n} ) = \frac{f ( {o}_{n} \vert {c}_{i} ) p ( {c}_{i} )}{{\sum }_{i} f ( {o}_{n} \vert {c}_{i} ) p ( {c}_{i} )} \qquad ( 12 )$$

where p(cᵢ) is the prior probability of the event. Assuming no prior knowledge about the events, p(cicᵢ) can be dropped from Eq. (12), which is then simplified as

$$p ( {c}_{i} \vert {o}_{n} ) = \frac{f ( {o}_{n} \vert {c}_{i} )}{{\sum }_{i} f ( {o}_{n} \vert {c}_{i} )} \qquad ( 13 )$$

Let P(cᵢ|oₙ) be denoted as pₙⁱ. It can be interpreted as the expected frequency of event cᵢ at n^{th} frame, with the following properties, (a) 0≦pₙⁱ≦1, (b). A frame is represented by a vector of continuous value as illustrated in FIG. 12, which can be thought of a soft-indexing approach as opposed to the hard-indexing approach for music frame using n-gram counting in FIG. 11. The soft-indexing reflects how a frame is represented by the whole model space while the hard-indexing estimates the n-gram count based on the top-best tokenization results. As noted above, although the hard-indexing technique provides acceptable results, the soft-indexing technique provides a higher resolution vector representation for a music frame as will be described below.

Assuming the music frames are independent each other, the joint posteriori probability of two events i and j between two frames, n^{th} and (n+1)^{th} can be estimated as

pₙ^{i,j}=pₙⁱ×pₙ₊₁^{j} (14)

where Pₙ^{i,j} has similar properties as Pₙⁱ, (a) 0≦Pₙ^{i,j}≦1, (b) Σᵢ₌₁⁴⁸Σᵢ₌₁⁴⁸pₙ^{i,j}=1. For a query of N frames, the expected frequency of unigram and bigram can be estimated as

E{f_{N}ⁱ}=Σₙ₌₁^{N}pₙⁱ (15)

E{f_{N}^{i,j}}Σₙ₌₁^{N}pₙ^{i,j} (16)

Thus the soft-indexing vector for query E{\vec{f}_{N}ⁱ(q)} and music segment E{\vec{f}_{N}ⁱ(d)}. Replacing \vec{f}_{N}(q) with E{\vec{f}_{N}ⁱ(q)}, \vec{f}_{N}ⁱ(d) with E{\vec{f}_{N}ⁱ(d)} in Equation 12 and Equation 13, the similar relevance scores can be used for soft-indexing ranking.

FIG. 13 shows schematically how an n-gram vector 1302 is constructed by the vector construction module using N frames 1304 of unigram vector and how the relevance score 1306 is evaluated between a query music segment 1308 and a stored music segment 1310. This process may be carried out as a stand-alone process. Optionally, the search space of the query music segment 1308 in the music database can be restricted. Firstly, the tempo rhythm cluster of the query clip is determined as described above. Then, the search for matches within the music database is restricted to stored music segments in the database within the same cluster, or integer multiples thereof.

This processing is carried out by vector comparison module 906 of FIG. 9 which determines a similarity score representing a similarity between a query music vector associated with the query music segment and a stored music vector associated with the stored music segment. In this case, the query music vector(s) 1304 associated with query music segment 1308 is compared with (plural) stored music vector(s) 1310 associated with stored music segment 1312.

Although we use two-dimensional coordinate for the bigram count, the vector can be treated as a one-dimensional array. The process of deriving unigram and bigram vectors for a music segment involves minimum computation. In practice, those vectors are computed at run-time directly from the chord/acoustic transcripts resulting from the tokenization. Note that the tokenization process evaluates a music frame against all the chord/acoustic models at higher computational cost. This can be done off-line.

The MIR process evaluates the similarity between a query music segment and all the candidate music segments. For simplicity, the chord unigram vector (48 dimension) is denoted \vec{f}_{N}ⁱ(q) and \vec{f}_{N}^{i,j} (q) denotes the chord bigram vector (2,304 dimension) for a query of N frames. Similarly, a chord unigram vector \vec{f}_{N}ⁱ(d) and a chord bigram vector \vec{f}_{N}^{i,j}(d) can be obtained from any segment of N frames in the music database.

The similarity between two n-gram vectors is determined from a comparison of the two unigram and two bigram vectors respectively is as follows:

$$\begin{matrix}s ( {\vec{f}}_{N}^{i} ( q ) , {\vec{f}}_{N}^{i} ( d ) ) = \frac{( {\vec{f}}_{N}^{i} ( q ) \cdot {\vec{f}}_{N}^{i} ( d ) )}{\vert {\vec{f}}_{N}^{i} ( q ) \vert \times \vert {\vec{f}}_{N}^{i} ( d ) \vert} & ( 10 ) \\ s ( {\vec{f}}_{N}^{i , j} ( q ) , {\vec{f}}_{N}^{i , j} ( d ) ) = \frac{( {{f}^{}}_{N}^{i , j} ( q ) \cdot {{f}^{}}_{N}^{i , j} ( d )}{\vert {{f}^{}}_{N}^{i , j} ( q ) \vert \times \vert {\vec{f}}_{N}^{i , j} ( d ) \vert} & ( 11 )\end{matrix}$$

Ranking module 908 then ranks the stored music segments according to their relevance from the similarity comparison to the query music segment. This is done as a measure of the distance between the respective vectors. The relevance is can be defined by the fusion of unigram and bigram similarity scores. The fusion can be made, for example, as simple addition of the unigram and bigram scores or, in the alternative, as an averaging of these.

In a simulation, chord and acoustic modelling performance was studied first followed by MIR experiments. The apparatus used in the simulation was apparatus 1600 of FIG. 16 which provides a more detailed illustration of the apparatus of FIG. 2.

A song database 1602 is processed by apparatus 1600. The rhythm extraction, beat segmentation and silence detection process of FIG. 3 is performed by module 1604. Following this, the chord/harmony event modelling of FIG. 5 is performed by modules 1608 and 1614. In parallel with this, the music region content extraction and acoustic event modelling of FIG. 7 is performed by modules 1606 and 1612. Module 1610 determines the tempo/rhythm cluster.

Similar processes are carried out for a query music clip (segment) 1620 to derive a query music vector 1622.

Tokenization, indexing and vector comparison (distance calculation) are carried out by module 1616. The indexed music content database is illustrated at 1618. The n-gram relevance ranking is carried out at 1624 between the query music clip vector 1622 and the indexed music content databases 1618. A list or results of possible matches are returned at 1624. In one implementation, the most likely candidate for the query is returned as a single result.

A song database DB1 for MIR experiments was established, extracted from original music CDs, digitized at 44.1 kHz sampling rate with 16 bits per sample in mono channel format. The retrieval database comprises 300 songs by 20 artists as listed in Table 2, each on average contributing 15 songs. The tempos of the songs are in the rage of 60-180 beats per minute.

Each of the 48 chord models is a two-layer representation of Gaussian mixtures as in FIG. 5. The models were trained with annotated samples in a chord database (CDB). The CDB included recoded chord samples from original instruments (string type, bow type, blowing type, etc) as well as synthetic instruments (software generated). In addition, the CDB also included chord samples extracted from 40 CDs of quality English songs, a subset of DB1, with the aid of music sheets and listening tests. Therefore DB1 included around 10 minutes of each chord samples spanning from C2 to B8. 70% of the samples of each chord were used for training and the remaining 30% for testing in cross validation setup. Experimental results are shown in FIG. 14. The results of proposed two-layer model (TLM) are compared with single layer model (SLM) in FIG. 14. A single layer chord model was constructed using 128 Gaussian mixtures. General PCP features vectors (G-PCP) were used for training and testing the SLMs. The computation of the α^{th} coefficient of the G-PCP feature vectors was calculated in accordance with Equation 17:

G−PCPⁿ(α)=Σ_{OC=1}⁷PCP_{OC}ⁿ(α) (17)

It was noted that the proposed TLM with feature extracted from BSS outperformed the SLM approach by 5% in absolute accuracy.

The compare performance of OSCCs and MFCCs for modelling regions PI and V was compared. SVD analysis depicted in FIG. 8 highlighted that OSCCs characterise music content more uncorrelated than MFCCs. In this experiment, 100 English songs were selected (10 songs per artist and 5 artists per gender) from DB1. The V and PI regions were annotated. Each V and PI class information was then modelled with 64 GMs. 100 songs were used by cross validation where 60/40 songs were used as training/testing in each turn.

Table 3 shows the correct region detection accuracies for an optimized number of both the filters and coefficients of MFCC and OSCC features. The correct detection accuracy for PI-region and V-region is reported, when the frame size is equal to beat space. The accuracy when fixing the frame size to 30 ms is reported. Both OSCC and MFCC performed better when the frame size is beat space. OSCC generally outperformed MFCC, and is therefore particularly useful for modelling acoustic events.

In DB1, 4 clips of 30-second music were selected as queries from each artist in the database, totaling 80 clips. Out of 4 clips, two clips belong to V region and other two belonged mainly to PI region. For a given query, the relevance score between a song and the query is defined as the sum of the similarity score between the top K most similar indexing vectors and the query vector. Typically, K is set to be 30.

After computing the smallest note length in the query, check the tempo/rhythm clusters of the songs in the data base is checked. For song relevance ranking, only the songs whose smallest note lengths are in the same range (with ±30 ms tolerance) are considered as the smallest note length of the query or integer multiples of them. Then the surviving songs in the DB1 were ranked according to their respective relevance scores.

FIG. 15 shows the average accuracy of the correct song retrieval when the query length was varied from 2-sec to 30-sec. Both chord events and acoustic events were considered for constructing n-gram vectors. The average accuracy of correct song retrieval in top choice was around 60% for the query length varying from 15˜30-sec. For the similar query lengths, the retrieval accuracy for top-5 candidates was improved by 20%.

In Table 4 the chord event effect and combined effects of chord and acoustic events in terms of retrieval accuracy is shown.

The simulations show that the vector space modelling is effective in representing the layered music information, achieving 82.5% top-5 retrieval accuracy using 15-sec music clips as the queries.

It can be found that the soft-indexing outperforms hard-indexing see Equations 8 and 9. In general, combining acoustic events and chord events yields better performance. This can be understood by the fact that similar chord patterns are likely to occur in different songs. The acoustic content helps differentiate one from another.

Thus, in summary, the disclosed techniques have proposed a novel framework for MIR. The contribution of these techniques include:
a layered music information representation (timing, harmony and music region contents);
the statistical modelling of harmony and music region contents;
the vector space modelling of music information;
two retrieval models for music indexing and retrieval: hard-indexing and soft-indexing.

It has been found that octave scale music information modelling followed by the inter-beat interval proportion segmentation is more efficient than known fixed length music segmentation techniques. In addition, the disclosed soft-indexing retrieval model may be more effective than the disclosed hard-indexing one, and may be able to index greater details of music information.

The fusion of chord model and acoustic model statistics improves retrieval accuracy effectively. Further, music information in different layers complements each other in achieving improved MIR performance. The robustness in this retrieval modelling framework depends on how well the information is captured.

Even though music retrieval is the prime application in this framework, proposed vector space music modelling framework is useful for developing many other applications such as music summarization, streaming, music structure analysis, and creating multimedia documentary using music semantics. Thus, the disclosed techniques have application in other relevant areas.

It will be appreciated that the invention has been described by way of example only and that various modifications may be made in detail without departing from the spirit and scope of the appended claims. It will also be appreciated that features presented in combination in one aspect of the invention may be freely combined in other aspects of the invention.

### REFERENCES

[1] Typke, R., Wiering, F., and Veltkamp, R. A Survey of Music Information Retrieval Systems. In Proc. of the ISMIR, September 2005.
[2] Pickens, J. A Survey of Feature Selection Techniques for Music Information Retrieval. Technical report, Center of Intelligent Information Retrieval, Dept. of Computer Science, University of Massachusetts, 2001.
[3] Lemström, K., and Laine, P. Music Information Retrieval using Musical Parameters. In Proc. of the ICMC, October, 1998.
[4] Berenzweig, A., Logan, B., Ellis, D. P. W., and Whitman, B. A Large-Scale Evaluation of Acoustic and Subjective Music-Similarity Measures. In Computer Music Journal, Summer, 2004, 63-74.
[5] Ghias, A., Logan, J., Chamberlin, D., and Smith, B. C. Query by Humming: Musical Information Retrieval in an Audio Database. In Proc. of ACM MM, November, 1995.
[6] Downie, J. S., and Nelson, M. Evaluating a Simple Approach to Music Information Retrieval Method. In Proc. ACM SIGIR, July 2000.
[7] Kageyama, T., Mochizuki, K., and Takashima, Y. Melody Retrieval with Humming. In Proc. ICMC, September, 1993.
[8] McNab, R. J., Smith, L. A., Witten, I. H., Henderson, C. L., and Cunningham, S. J. Towards the Digital Music Library: Tune Retrieval from Acoustic Input. In Proc. ACM Digital Libraries, March, 1996.
[9] Foote, J. Visualizing Music and Audio Using Self-Similarity. In Proc. ACM MM, October, 1999.
[10] Chai, W., Vercoe, B. Structure Analysis of Music Signals for Indexing and Thumbnailing. In Proc. of the ACM/IEEE JCDL, May 2003.
[11] Doraisamy, S., and Rüger, S. Robust Polyphonic Music Retrieval with N-Grams. In Journal of Intelligent Information Systems. Vol 21, No. 1. pp 53-70, 2003.
[12] Song, J., Bae, S. Y., and Yowl, K. Mid-Level Music Melody Representation of Polyphonic Audio for Query-by-Humming System. In Proc. of ISMIR, October, 2002.
[13] Shih, H.-H., Narayanan, S. S., and Kuo, C.-C. J. An HMM-Based Approach to Humming Transcription. In Proc. of ICME, August, 2002.
[14] Deller, J. R., Hansen, J. H. L., and Proakis, H. J. G. Discrete-Time Processing of Speech Signals, IEEE Press, 2000.
[15] Maddage C. N., Xu, C., Kankanhalli, M. S., and Shao, X, Content-based Music Structure Analysis with the Applications to Music Semantic Understanding, In ACM Multimedia Conference, October 2004
[16] Fujishima, T. Real Time Chord Recognition of Musical Sound: A System Using Lisp Music. In Proc. ICMC, October 1999.
[17] Goldstein, J. L. An Optimum Processor Theory for the Central Formation of the Pitch of Complex Tones. In JASA, Vol. 54, 1973.
[18] Terhardt, E. Pitch, Consonance and Harmony. In JASA, Vol. 55, No. 5, 1974.
[19] Ward, W. Subjective Music Pitch. In JASA, Vol. 26, 1954.
[20] Duxburg. C, Sandler. M., and Davies. M. A Hybrid Approach to Musical Note Onset Detection. In Proc. Int. Conf. DAFx. Hamburg, Germany, September, 2002.
[21] G. Salton, The SMART retrievl system. Prentice-Hall, Englewood Cliffs, N.J., 1971.
[22] Cavnar, W. B., and Trenkle, J. M. N-Gram-Based Text Categorization. In Proc. of 3^{rd} Annual Symposium on Document Analysis and Information Retrieval, 1994.
[23] Ma, B., and Li, H., A Phonotactic-Semantic Paradigm for Automatic Spoken Document Classification. In Proc. of ACM SIGIR, August, 2005.
[24] Uitdenbogerd, A. L., and Zobel, I. An architecture for effective music information retrieval. In Journal of the American Society for Information Science and Technology, Vol. 55, No. 12, pp. 1053-1057, 2004.

1. An apparatus for modelling layers in a music signal, the apparatus comprising:
a rhythm modelling module configured to model rhythm features of the music signal;
a harmony modelling module configured to model harmony features of the music signal; and
a music region modelling module configured to model music region features from the music signal.

2. Apparatus according to claim 1, wherein the rhythm modelling module is configured to model one or more of beat, bar, tempo, note duration and silence of the music signal.

3. Apparatus according to claim 1, wherein the harmony modelling module is configured to model one or more of harmony and melody of the music signal.

4. Apparatus according to claim 1, wherein the music region modelling module is configured to model one or more of pure instrumental, pure vocal, and instrumental mixed vocal regions of the music signal.

5. Apparatus according to claim 1, wherein the rhythm modelling module is configured to determine a smallest note length of a music signal, the apparatus comprising:
a summation module configured to derive a composite onset of the music signal from a weighted summation of octave sub-band onsets of the music signal;
an autocorrelation module configured to perform an autocorrelation of the composite onset of the music signal thereby to derive an estimated inter-beat proportional note length;
an interval length determination module configured to determine a repeating interval length between dominant onsets when the estimated inter-beat proportional note length is varied; and
a note length determination module configured to determine a smallest note length from the repeating interval length.

6. Apparatus according to claim 1, wherein the rhythm modelling module is configured to determine a smallest note length of a music signal, the apparatus comprising:
octave sub-band onset determination modules configured to determine octave sub-band onsets of the music signal from a frequency transient analysis and an energy transient analysis of a decomposed version of the music signal;
a summation module configured to derive a composite onset of the music signal from a weighted summation of octave sub-band onsets of the music signal;
an autocorrelation module configured to perform a circular autocorrelation of the composite onset of the music signal thereby to derive an estimated inter-beat proportional note length;
a dynamic programming module configured to determine patterns of equally spaced intervals between dominant onsets when the estimated inter-beat proportional note length is varied; and
a note length determination module configured to determine a smallest note length from the most common smallest interval of the equally spaced intervals which is also an integer fraction of longer intervals.

7. Apparatus according to claim 1, wherein the harmony modelling module is configured to model chords of a music signal, the apparatus comprising:
octave filter banks configured to receive a music signal segmented into frames and to extract tonal characteristics of musical notes in frames;
a vector construction module configured to construct pitch class profile vectors from the tonal characteristics;
a first layer model configured to be trained by the pitch class profile vectors and to output probabilistic vectors; and
a second layer model configured to be trained by the probabilistic vectors thereby to model chords of the music signal.

8. Apparatus according to claim 1, wherein the music region content modelling module is configured to model music region content of a segmented music signal, the apparatus comprising:
octave scale filter banks configured to receive a frame of a segmented music signal and to derive a frequency response of the segmented music signal; and
a first coefficient derivation module configured to derive octave cepstral coefficients of the music signal from the frequency response of the octave filter banks and to derive feature matrices comprising octave cepstral coefficients of the music signal for music regions.

9. Apparatus according to claim 1 configured to tokenize a segmented music signal, the apparatus comprising a tokenizing module configured to receive a frame of the segmented music signal and to determine a probability the frame of the music signal corresponds with a token symbol of a token library, and to determine a token for the frame accordingly.

10. Apparatus according to claim 9 configured to construct a vector of a tokenized music signal, the apparatus comprising a vector construction module configured to construct a vector having a vector element defining a token symbol score for the frame of the tokenized music signal.

11. Apparatus according to claim 10 configured to determine a similarity between a query music segment and a stored music segment, the apparatus comprising a vector comparison module configured to determine a similarity score representing a similarity between a query music vector associated with the query music segment and a stored music vector associated with the stored music segment.

12. Apparatus for modelling chords of a music signal, the apparatus comprising:
octave filter banks configured to receive a music signal segmented into frames and to extract tonal characteristics of musical notes in frames;
a vector construction module configured to construct pitch class profile vectors from the tonal characteristics;
a first layer model configured to be trained by the pitch class profile vectors and to output probabilistic vectors; and
a second layer model configured to be trained by the probabilistic vectors thereby to model chords of the music signal.

13. Apparatus according to claim 12, wherein each octave filter bank comprises twelve filters centred on respective fundamental frequencies of respective notes in each octave.

14. Apparatus according to claim 13, wherein each filter is configured to capture strengths of the fundamental frequencies of its respective note and sub-harmonics and harmonics of related notes.

15. Apparatus of claim 12, wherein the vector construction module is configured to derive an element of a pitch class profile vector from a sum of strengths of a note of the frame and strengths of sub-harmonics and harmonics of related notes.

16. Apparatus for modelling music region content of a segmented music signal, the apparatus comprising:
octave scale filter banks configured to receive a frame of a segmented music signal and to derive a frequency response of the segmented music signal; and
a first coefficient derivation module configured to derive octave cepstral coefficients of the music signal from the frequency response of the octave filter banks and to derive feature matrices comprising octave cepstral coefficients of the music signal for music regions.

17. Apparatus according to claim 16, the apparatus comprising first and second gaussian mixture modules configured to be trained by octave cepstral coefficient feature vectors.

18. Apparatus according to claim 16, further comprising a second coefficient derivation module configured to derive mel frequency cepstral coefficients of the segmented music signal.

19. Apparatus according to claim 18, further comprising a decomposition module configured to compare a correlation of octave cepstral coefficients and the mel frequency cepstral coefficients.

20. Apparatus for tokenizing a segmented music signal, the apparatus comprising a tokenizing module configured to receive a frame of the segmented music signal and to determine a probability the frame of the music signal corresponds with a token symbol of a token library, and to determine a token for the frame accordingly.

21. Apparatus according to claim 20, wherein the token symbol comprises a chord event and the token library comprises a library of modelled chords, the tokenizing module being configured to determine a probability the frame of the music signal corresponds with a chord event.

22. Apparatus according to claim 20, wherein the token symbol comprises an acoustic event and the token library comprises a library of acoustic events, the tokenizing module being configured to determine a probability the frame of the music signal corresponds with an acoustic event.

23. Apparatus according to claim 22, wherein the acoustic event comprises at least one of a voice event or an instrumental event.

24. Apparatus for constructing a vector for a frame of a tokenized music signal, the apparatus comprising a vector construction module configured to construct a vector having a vector element defining a token symbol score for the frame of the tokenized music signal.

25. Apparatus according to claim 24, wherein the vector construction module is configured to define the vector element as a binary score of whether the frame corresponds with a token symbol.

26. Apparatus according to claim 24, wherein the vector construction module is configured to define the vector element as a probability score of whether the frame corresponds with a token symbol.

27. Apparatus according to claim 26, wherein the vector construction module is configured to define the vector element as a score between zero and unity.

28. Apparatus according to claim 26 or claim 27, wherein the vector construction module is configured to define the vector elements so that a sum of the vector elements within the vector is unity.

29. Apparatus according to claim 24, wherein the token symbol comprises a chord event and the vector construction module is configured to construct a chord unigram vector for the frame of the tokenized music signal.

30. Apparatus according to claim 24, wherein the token symbol comprises a chord event and the vector construction module is configured to construct a chord bigram vector for consecutive frames of the tokenized music signal.

31. Apparatus according to claim 24, wherein the token symbol comprises an acoustic event and the vector construction module is configured to construct an acoustic unigram vector for a frame of the tokenized music signal.

32. Apparatus according to claim 24, wherein the token symbol comprises an acoustic event and the vector construction module is configured to construct an acoustic bigram vector for consecutive frames of the tokenized music signal.

33. Apparatus for determining a similarity between a query music segment and a stored music segment, the apparatus comprising a vector comparison module configured to determine a similarity score representing a similarity between a query music vector associated with the query music segment and a stored music vector associated with the stored music segment.

34. Apparatus according to claim 33, wherein the vector comparison module is configured to determine a similarity between a query music vector associated with the query music segment and plural stored music vectors associated with the stored music segment.

35. Apparatus for determining a similarity between a query music segment and stored music segments, the apparatus comprising a vector comparison module configured to determine a similarity between a query music vector associated with the query music segment and respective stored music vectors associated with the stored music segments.

36. Apparatus according to claim 33, wherein the vector comparison module is configured to determine a unigram similarity score representing a similarity between respective unigram vectors associated with the query music segment and the stored music segment.

37. Apparatus according to claim 33, wherein the vector comparison module is configured to determine a bigram similarity score representing a similarity between respective bigram vectors associated with the query music segment and the stored music segment.

38. Apparatus according to claim 37, wherein the vector comparison module is configured to fuse the unigram similarity score and the bigram similarity score to provide a composite similarity score.

39. Apparatus according to claim 33, wherein the apparatus further comprises a ranking module configured to rank similarities of the query music sample with stored music samples according to similarity scores of the query music vector with plural stored music segments.

40. A method of modelling layers in a music signal, the method comprising:
modelling rhythm features of the music signal;
modelling harmony features of the music signal; and
modelling music region features from the music signal.

41. The method of claim 40, wherein the modelling of rhythm features of the music signal comprises determining a smallest note length of a music signal, the method further comprising:
deriving a composite onset of the music signal from a weighted summation of octave sub-band onsets of the music signal;
performing an autocorrelation of the composite onset of the music signal thereby to derive an estimated inter-beat proportional note length;
determining a repeating interval length between dominant onsets when the estimated inter-beat proportional note length is varied; and
determining a smallest note length from the repeating interval length.

42. The method of claim 40, wherein the modelling of rhythm features of the music signal comprises determining a smallest note length of a music signal, the method further comprising:
determining octave sub-band onsets of the music signal from a frequency transient analysis and an energy transient analysis of a decomposed version of the music signal;
deriving a composite onset of the music signal from a weighted summation of octave sub-band onsets of the music signal;
performing a circular autocorrelation of the composite onset of the music signal thereby to derive an estimated inter-beat proportional note length;
determining patterns of equally spaced intervals between dominant onsets when the estimated inter-beat proportional note length is varied; and
determining a smallest note length from the most common smallest interval of the equally spaced intervals which is also an integer fraction of longer intervals.

43. The method of claim 40, wherein the modelling of harmony features of the music signal comprises modelling chords of a music signal, the method further comprising:
receiving at octave filter banks a music signal segmented into frames and extracting tonal characteristics of musical notes in frames;
constructing pitch class profile vectors from the tonal characteristics;
training a first layer model by the pitch class profile vectors and outputting probabilistic vectors; and
training a second layer model by the probabilistic vectors thereby to model chords of the music signal.

44. The method of claim 40, wherein the modelling of music region content comprises modelling music region content of a segmented music signal, the method further comprising:
receiving at octave scale filter banks a frame of a segmented music signal and deriving a frequency response of the segmented music signal; and
deriving octave cepstral coefficients of the music signal from the frequency response of the octave filter banks and deriving feature matrices comprising octave cepstral coefficients of the music signal for music regions.

45. The method of claim 40, the method further comprising tokenizing a segmented music signal, the method comprising receiving a frame of a segmented music signal and determining a probability a frame of the music signal corresponds with a token symbol of a token library, and determining a token for the frame accordingly.

46. The method of claim 45, further comprising constructing a vector of a tokenized music signal by constructing a vector having a vector element defining a token symbol score for the frame of the tokenized music signal.

47. The method of claim 46, further comprising determining a similarity between a query music segment and a stored music segment, the method comprising determining a similarity score representing a similarity between a query music vector associated with the query music segment and a stored music vector associated with the stored music segment.

48. A method of modelling chords of a music signal, the method comprising:
receiving at octave filter banks a music signal segmented into frames and extracting tonal characteristics of musical notes in frames;
constructing pitch class profile vectors from the tonal characteristics;
training a first layer model by the pitch class profile vectors and outputting probabilistic vectors; and
training a second layer model by the probabilistic vectors thereby to model chords of the music signal.

49. A method of modelling music region content of a segmented music signal, the method comprising:
receiving at octave scale filter banks a frame of a segmented music signal and deriving a frequency response of the segmented music signal; and
deriving octave cepstral coefficients of the music signal from the frequency response of the octave filter banks and deriving feature matrices comprising octave cepstral coefficients of the music signal for music regions.

50. A method of tokenizing a segmented music signal, the method comprising receiving a frame of the segmented music signal at a tokenization module and determining a probability the frame of the music signal corresponds with a token symbol of a token library, and determining a token for the frame accordingly.

51. A method of constructing a vector for a frame of a tokenized music signal, the method comprising constructing a vector having a vector element defining a token symbol score for the frame of the tokenized music signal.

52. A method of determining a similarity between a query music segment and a stored music segment, the method comprising determining a similarity score representing a similarity between a query music vector associated with the query music segment and a stored music vector associated with the stored music segment.

53. A computer readable medium having computer code stored thereon for implementing the method of claim 40.
